(19) United States
(12) Patent Application Publication
(10) Pub. No.: US 2017/0318282 A1
(43) Pub. Date: Nov. 2, 2017

(54) INPUT DEVICE WITH PROJECTING FUNCTION

(71) Applicant: PRIMAX ELECTRONICS LTD., Taipei (TW)

(72) Inventors: A-Ming Chang, Taipei (TW); Ying-Che Tseng, Taipei (TW); Cheng-Yi Tsai, Taipei (TW)

(21) Appl. No.: 15/215,236

(22) Filed: Jul. 20, 2016

(30) Foreign Application Priority Data
Apr. 29, 2016 (TW) 105113490

(51) Int. Cl. H04N 13/04; H04N 9/31; G06T 15/20; G06F 3/041

(52) U.S. Cl. CPC H04N 13/0452; H04N 13/0459; G06F 3/0416; G06T 15/20; H04N 9/3179

(57) ABSTRACT

An input device with a projecting function is provided, including: a first input device and a second input device. The first input device has a first projection unit, and the second input device has a second projection unit. The first projection unit and the second projection unit are configured to execute 2D projection or 3D projection. When a projection direction of the first projection unit is the same as that of the second projection unit, the first projection unit and the second projection unit execute the 2D projection. When the projection direction of the first projection unit is perpendicular to that of the second projection unit, the first projection unit and the second projection unit execute the 3D projection. The present disclosure provides a relatively sharp 2D projected image and a function of simplifying a structure of an input device.

### FIELD OF THE INVENTION

The present invention relates to an input device, and more particularly to an input device with a projecting function.

### BACKGROUND OF THE INVENTION

Recently, more and more users carry and share information by using a portable electronic device, such as a cell phone or a tablet computer. As compared with a notebook computer, a portable electronic device has an advantage of being portable. However, a portable electronic device inputs data in a touch input manner. Therefore, as compared with a keyboard, a manner of inputting data from a touchpad is slow and inconvenient.

To improve this problem, in the prior art, many portable input devices are developed. The volume of an input device of such type is smaller than that of a keyboard of a common computer, but the input device is capable of providing an input manner the same as that of an input operation of the keyboard, so as to resolve a problem that data input of a portable electronic device is inconvenient.

Besides the problem of data input, a user also encounters a problem during a process of using a portable electronic device to share data. A common manner of presenting computer data to the outside is using a projector. For a portable electronic device, an objective of presenting data may be achieved by using a mini portable projection device. However, multiple devices need to be carried at the same time, such as an input device and a projection device, so as to provide a complete usage effect. The foregoing practice is inconvenient to a user.

Therefore, in the prior art, a keyboard with a projecting function is provided. The keyboard is provided with a projection device, so that information input and projection functions may be provided by using a single device. A conventional keyboard with a projecting function uses multiple projection devices, so as to provide two-dimensional (2D) and three-dimensional (3D) projection functions. It is known that a keyboard with a projecting function performs 2D projection by using a single projection device. However, taking costs into consideration, the projection device disposed in the keyboard is usually not a high-end projection device, and therefore, the sharpness of a generated 2D projected image is not ideal. Besides, although the keyboard of such type provides a 3D projection function, during an operation, an element such as a polarizer needs to be added, so as to generate a 3D projection effect, which adds difficulty to structure simplification of the keyboard device.

### SUMMARY OF THE INVENTION

A main objective of the present invention is to provide an input device with a projecting function for providing a relatively sharp 2D projected image.

A main objective of the present invention is to provide a structure-simplified input device with a projecting function.

In accordance with a preferred embodiment of the present invention, an input device with a projecting function is provided, where the input device has image data of a planar image for 2D projection, and data about images of multiple visual angles corresponding to the multiple visual angles of an object for 3D projection. The input device includes a first input device and a second input device. The first input device generates a first input signal and includes: a first processor, where the first processor performs operation on the image data of the planar image to generate first 2D projection data and second 2D projection data; and a first projection unit, configured to perform 2D projection according to the first 2D projection data, or perform 3D projection according to first 3D projection data. A second input device is rotatably connected to the first input device. The second input device generates a second input signal and includes: a second processor, where the second processor performs operation on the data about the images of the plurality of visual angles to generate first 3D projection data and second 3D projection data; and a second projection unit, configured to perform the 2D projection according to the second 2D projection data, or perform the 3D projection according to the second 3D projection data. When a projection direction of the first projection unit is the same as a projection direction of the second projection unit, the first projection unit and the second projection unit execute the 2D projection, and the planar image projected by the second projection unit is overlapped with the planar image projected by the first projection unit; and when a projection direction of the first projection unit is perpendicular to a projection unit of the second projection unit, the first projection unit and the second projection unit execute the 3D projection, and the first 3D projection data projected by the first projection unit and the second 3D projection data projected by the second projection unit form a 3D image of the object in the air.

### BRIEF DESCRIPTION OF THE DRAWINGS

FIG. 1 is a schematic diagram of an appearance of a preferred embodiment of an input device with a projecting function according to the present invention;

FIG. 2 is a schematic block diagram of a preferred embodiment of the input device with a projecting function according to the present invention;

FIG. 3 is a schematic diagram of a preferred embodiment of 2D projection performed by the input device with a projecting function according to the present invention; and

FIG. 4 is a schematic diagram of a preferred embodiment of 3D projection performed by the input device with a projecting function according to the present invention.

### DETAILED DESCRIPTION OF THE PREFERRED EMBODIMENTS

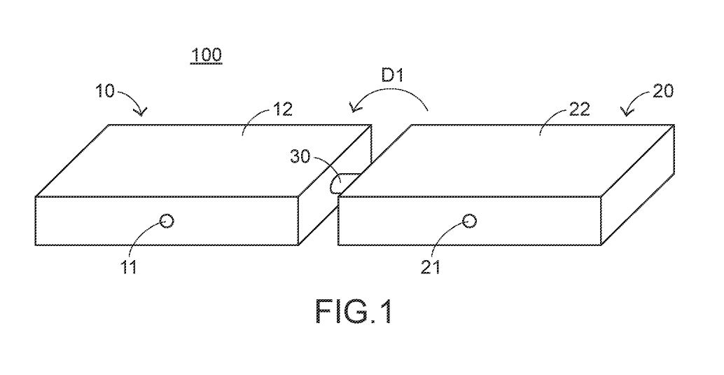

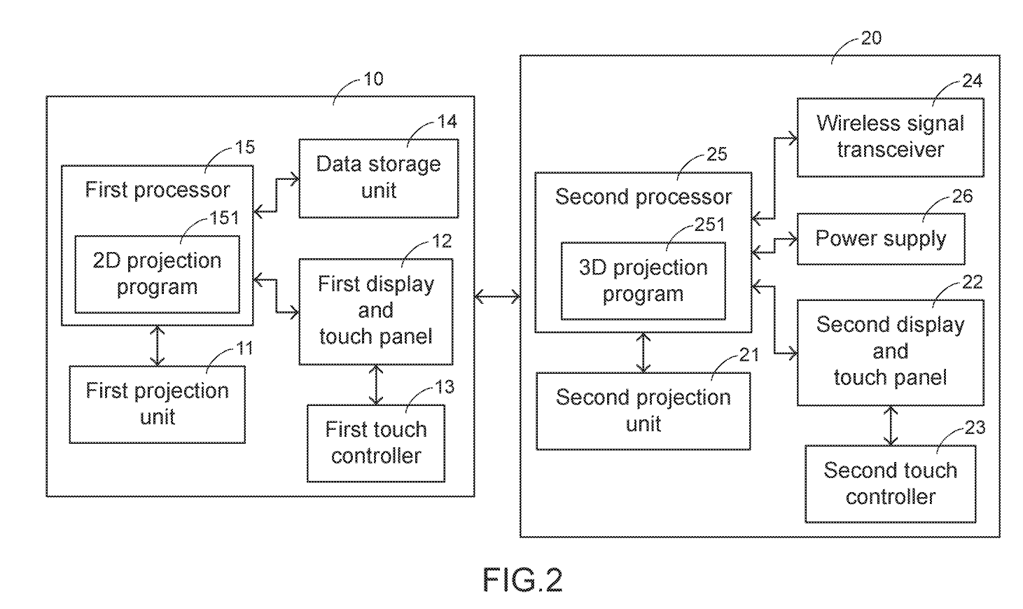

Referring to FIG. 1 and FIG. 2, FIG. 1 is a schematic diagram of an appearance of a preferred embodiment of an input device with a projecting function according to the present invention, and FIG. 2 is a schematic block diagram of a preferred embodiment of the input device with a projecting function according to the present invention. In the embodiments of FIG. 1 and FIG. 2, an input device 100 of the present invention includes a first input device 10 and a second input device 20. The first input device 10 includes a first projection unit 11, a first display and touch panel 12, a first touch controller 13, a data storage unit 14, and a first processor 15. The first processor 15 further includes a 2D projection program 151. The second input device 20 includes a second projection unit 21, a second display and touch panel 22, a second touch controller 23, a wireless signal transceiver 24, a second processor 25, and a power supply 26. The second processor 25 further includes a 3D projection program 251. It should be specifically noted that, the configuration that the data storage unit 14 of this embodiment is disposed in the first input device 10, and the wireless signal transceiver 24 and the power supply 26 are disposed in the second input device 20 is merely used as an example for illustration, and is not intended to limit the present invention.

As shown in FIG. 1, the first input device 10 is connected to the second input device 20 by using a rotation shaft 30. Therefore, the second input device 20 may rotate upwards (D1 direction) relative to the first input device 10, so as to overlap the first input device 10, making the input device be portable. Besides, the first projection unit 11 is disposed in the first input device 10 and is partially exposed from a side surface of the first input device 10, and the second projection unit 12 is disposed in the second input device 20 and is partially exposed from a side surface of the second input device 200. The first display and touch panel 12 is disposed on an upper surface of the first input device 10, and the second display and touch panel 22 is disposed on an upper surface of the second input device 20. Therefore, a user may see control images displayed by the first display and touch panel 12 and the second display and touch panel 22, and touches a corresponding image to generate a selected input signal.

The 2D projection program 151 of the first processor 15 is primarily used to generate 2D projection data for 2D projection. The 3D projection program 251 of the second processor 25 is used to generate 3D projection data for 2D projection. In this embodiment, the first processor 15 may be implemented by using a microcontroller, and it is suggested that the second processor 25 is implemented by using a central processing unit, so as to execute operation of 3D projection data that requires relatively intensive operation. The first projection unit 11 and the second projection unit 21 are used to execute 2D projection or 3D projection. The first touch controller 13 and the second touch controller 23 are separately used to control the first display and touch panel 12 and the second display and touch panel 22. Besides, the input device of the present invention may have an independent power supply 22 for the input device to use.

The input device of the present invention provides a two-dimensional (2D) projection function and a three-dimensional (3D) projection function. In a preferred embodiment, data, such as image data of a planar image for 2D projection and image data for 3D projection that are received from an external device by using the wireless signal transceiver 24, may be prestored in the data storage unit 14.

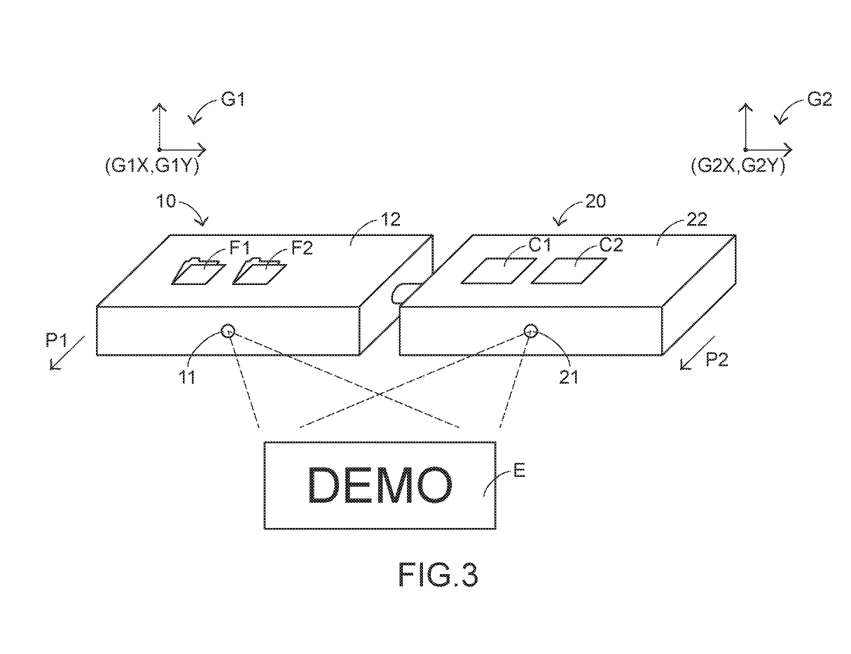

The following describes a manner of executing 2D projection of the present invention. Referring to FIG. 3, FIG. 3 is a schematic diagram of a preferred embodiment of 2D projection according to the present invention. When the 2D projection is executed, the first input device 10 and the second input device 20 are in a non-overlapping state. In this state, a projection direction P1 of the first projection unit 11 is the same as a projection direction P2 of the second projection unit 21. The first display and control panel 12 of the first input device 10 displays folder images F1 and F2 in the data storage unit 14, so that a user selects a folder that stores an image that the user intends to project. In the embodiment of FIG. 3, the user selects a folder “DEMO” that stores a planar image E. In addition, the second display and touch panel 22 of the second input device 20 displays functional images C1 and C2, so that a user selects a projection project that the user intends to execute. It should be noted that, alternatively, folder images and functional images may be displayed in a same input device. After an image to be projected is selected, the 2D projection program 151 of the first processor 15 performs operation on image data of an image E, so as to generate first 2D projection data and second 2D projection data. The second 2D projection data includes the first 2D projection data and a 2D coordinate system offset compensation value. Then, the first projection unit 11 externally projects the first 2D projection data to form an image E, and the second projection unit 21 externally projects the second 2D projection data to a position that overlaps the image E. The projected image E includes images projected by the first projection unit 11 and the second projection unit 21, and therefore, the image sharpness of the projected image E is superior to that of a projected image generated by a single projection unit.

It should be specifically noted that, to enable the first projection unit 11 and the second projection unit 21 to project to a same position, the second 2D projection data includes the 2D coordinate system offset compensation value. As shown in FIG. 3, the first projection unit 11 has a first 2D projection coordinate system G1 and the origin (G1X, G1Y) of the coordinate system, and the second projection unit 21 has a second 2D projection coordinate system G2 and the origin (G2X, G2Y) of the coordinate system. The 2D coordinate system offset compensation value may enable the origin (G2X, G2Y) of the second 2D projection coordinate system G2 to be changed to be consistent with the (G1X, G1Y) of the first 2D projection coordinate system G1. Therefore, the first projection unit 11 and the second projection unit 21 may project images that are overlapped with each other.

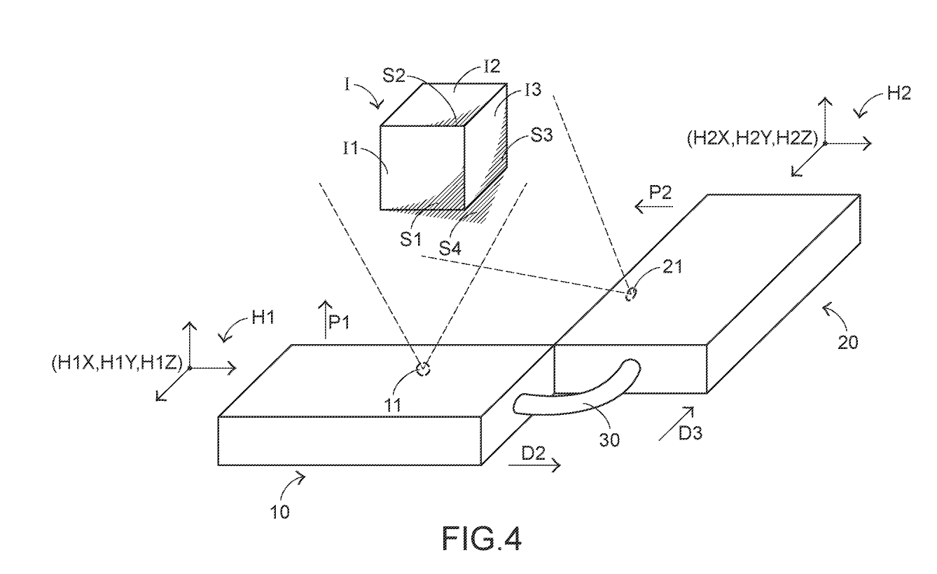

Referring to FIG. 4, FIG. 4 is a schematic diagram of a preferred embodiment of 3D projection performed by the input device with a projecting function according to the present invention. As shown in FIG. 4, when 3D projection is performed, an angle between the second input device 20 and the first input device 10 needs to be 90°, so as to enable the projection direction P1 of the first projection unit 11 to be perpendicular to the projection direction P2 of the second projection unit 21. One end of the rotation shaft 30 is flexibly connected to the first input device 10. The second input device 20 is made to move towards a direction D2 and then move towards a direction D3, so as to enable the angle between the second input device 20 and the first input device 10 to be 90°.

As described earlier, the data storage unit 14 stores data for 3D projection. FIG. 4 shows that an object to be projected is a cube I. In this embodiment, the image data for the 3D projection includes images of different visual angles of the cube I, that is, images of six surfaces of the cube I. In this embodiment, images of three surfaces I1, I2, and I3 that are seen from visual angles of FIG. 4 are used as examples. The 3D projection program 251 of the second processor 25 performs operation on data about images of different visual angles of the cube I, so as to generate first 3D projection data and second 3D projection data. The same as the 2D projection, the second 3D projection data includes a 3D coordinate system offset compensation value. As shown in FIG. 4, the first projection unit 11 has a first 3D projection coordinate system H1 and the origin (H1X, H1Y, H1Z) of the coordinate system, and the second projection unit 21 has a second 3D projection coordinate system H2 and the origin (H2X, H2Y, H2Z) of the coordinate system. The 3D coordinate system offset compensation value may enable the origin (H2X, H2Y, H2Z) of the second 3D projection coordinate system H2 to be changed to be consistent with the origin (H1X, H1Y, H1Z) of the first 3D projection coordinate system H1. Therefore, the first projection unit 11 and the second projection unit 21 may project to the same coordinate system.

In addition to the 3D coordinate system offset compensation value, the second 3D projection data further includes data about shadow images generated by the images of different visual angles of the cube I. In accordance with a principle of presenting a 3D image, marking of shadows enables an image to have a three-dimensional visual effect. Generally, an object has shadows in visual angles visible to a person, for example, in FIG. 4, shadows S1, S2, and S3 at corners of the images I1, I2, and I3, and a partial shadow S4 under the object I.

That is, the projection direction P1 of the first projection unit 21 is enabled to be perpendicular to the projection direction P2 of the second projection unit 21, so as to project images of different visual angles and shadow images of an object, thereby simply completing the 3D projection.

It can be known from the foregoing description that, with the input device of the description, the sharpness of a projected image is improved by enabling two projection units to project overlapped identical images. Besides, by means of a change of relative positions of two input devices, projection angles of the two projection devices being perpendicular to each other is easily achieved, and generation of images of different visual angles and shadow images of an object is used in combination, so as to achieve a 3D projection effect without using a polarizer, thereby simplifying a structure of an input device with a projecting function.

The foregoing descriptions are merely preferred embodiments of the present invention, but are not intended to limit the claims of the present invention. Therefore, equivalent variations or modifications without departing from the spirit of the present invention shall fall within the claims of the description.

What is claimed is:

1. An input apparatus with a projecting function, wherein the input device has image data of a planar image for two-dimensional (2D) projection, and data about images of multiple visual angles corresponding to the multiple visual angles of an object for three-dimensional (3D) projection; and the input device comprises:
a first input device, wherein the first input device generates a first input signal and comprises:
a first processor, wherein the first processor performs operation on the image data of the planar image to generate first 2D projection data and second 2D projection data; and
a first projection unit, configured to perform 2D projection according to the first 2D projection data, or perform 3D projection according to first 3D projection data; and
a second input device, rotatably connected to the first input device, wherein the second input device generates a second input signal and comprises:
a second processor, wherein the second processor performs operation on the data about the images of the multiple visual angles to generate the first 3D projection data and second 3D projection data; and
a second projection unit, configured to perform the 2D projection according to the second 2D projection data, or perform the 3D projection according to the second 3D projection data, wherein when a projection direction of the first projection unit is the same as a projection direction of the second projection unit, the first projection unit and the second projection unit execute the 2D projection, and the planar image projected by the second projection unit is overlapped with the planar image projected by the first projection unit; and when a projection direction of the first projection unit is perpendicular to a projection unit of the second projection unit, the first projection unit and the second projection unit execute the 3D projection, and the first 3D projection data projected by the first projection unit and the second 3D projection data projected by the second projection unit form a 3D image of the object in the air.

2. The input device with a projecting function according to claim 1, wherein the first projection unit has a first 2D projection coordinate system; the second projection unit has a second 2D projection coordinate system; and the second 2D projection data comprises the first 2D projection data and a 2D coordinate system offset compensation value.

3. The input device with a projecting function according to claim 1, wherein the first projection unit has a first 3D projection coordinate system; the second projection unit has a second 3D projection coordinate system; and the second 3D projection data comprises data about multiple shadows corresponding to the data about the images of the multiple visual angles, and a 3D coordinate system offset compensation value.

4. The input apparatus with a projecting function according to claim 1, further comprising: a data storage unit, configured to store image data for the 2D projection and the 3D projection.

5. The input device with a projecting function according to claim 1, wherein the first input device comprises a first display and touch panel, configured to display at least one first image, and generate the first input signal when the control image is touched; and the second input device comprises a second display and touch panel, configured to display at least one second image, and generate the first input signal when the control image is touched.

6. The input device with a projecting function according to claim 5, wherein the first image or the second image comprises multiple projection function options, so that a user may select to execute the 2D projection or the 3D projection.

7. The input device with a projecting function according to claim 5, wherein the first image or the second image comprises folder options.

8. The input device with a projecting function according to claim 1, wherein the first processor is a microcontroller, and comprises a 2D projection program configured to perform operation on image data for the 2D projection; and the second processor is a central processing unit, and comprises a 3D projection program, configured to perform operation on image data for the 3D projection.

9. The input device with a projecting function according to claim 1, further comprising: a first touch controller, disposed in the first input device and configured to control the first display and touch panel; and a second touch controller, disposed in the second input device and configured to control the second display and touch panel.
